(19) United States
(12) Patent Application Publication
(10) Pub. No.: US 2003/0204980 A1
(43) Pub. Date: Nov. 6, 2003

(54) Magnetic Shopping List

(76) Inventor: John R. Niec, San Leandro, CA (US)

Correspondence Address: JOHN NIEC, 118 DUTTON AVENUE, SAN LEANDRO, CA, 94577, US

(21) Appl. No.: 10/249,736

(22) Filed: May 5, 2003

Related U.S. Application Data
(60) Provisional application No. 60/377,752, filed on May 6, 2002.

(51) Int. Cl. G09F 7/04

(52) U.S. Cl. 40/600

(57) ABSTRACT

A system for compiling a grocery list comprised of a thin, planar magnetic receptive sheet (20) and a multitude of thin magnets (30 through 40) with words or indicia printed thereon which are transferred to the sheet, and the sheet and magnets being transported to market as a reminder of what to purchase or what activity to perform in conjunction with a shopping trip.

### CROSS REFERENCE TO RELATED APPLICATIONS

This invention relates to a grocery list devices, specifically which serves as a reminder of grocery items.

### BACKGROUND OF INVENTION

This invention relates to a grocery list devices, specifically which serves as a reminder of grocery items.

Prior Art

A person preparing a grocery list often writes the items he or she wishes to purchase on a piece of paper. At times the list is compiled immediately before departing for the grocery store. At other times the list is compiled as items are noticed in short supply.

However, the exact moment when an item is depleted or discovered to be in short supply may not be a convenient time to start a list or add an item to an existing list. Also, the means to create a list may not be readily at hand. Furthermore, if the list was started in advance of the shopping trip but not left in an obvious place, it may be temporarily lost, thus rendering the effort to create the list wasted.

When compiling the list, the lister does not necessarily write complete descriptions, because the lister's understanding of “sugar” means “Brand X sugar in the 5-pound bag.” However, the lister and the shopper are not necessarily the same person. In some cases, the shopping task may be designated to another, a spouse, other household member, or employee, etc. The shopper takes the list with them to the grocery store and selects the items on the list for purchase. If an item's description is ambiguous to the shopper, he must interpret the brand, quantity and other qualifiers the lister may have intended before he can select an item for purchase.

Numerous reminder devices exist in prior art to assist shoppers with inventory control, creating lists and transporting shopping lists to market. U.S. Pat. No. 4,817,320 issued to Fraynd relates to a magnetic shopper's reminder system including two display surfaces, one of which is labeled, “I Bet We Have It,” the other labeled, “I Bet We Need It.” These two display surfaces are made of metal and mounted to a wall with nails. Fraynd uses pictorial indicator elements that transfer between the two display surfaces serving as a visual reminder that certain items need to be replenished. The indicator elements have either a pictorial display or a 3-dimensional replication of a given category of goods, such as fish, fruit, cheese, bread, etc.

While the Fraynd's patent uses magnetic indicators and two boards to monitor inventory control, Fraynd does not address the following problems: first, the ambiguity of pictorial representations, second, a shopping trip might be conducted in conjunction with other household errands, and third, the lack of a convenient, integrated transport method. Fraynd considers pictorial representation “more efficient than actually defining the indicia means as a word, which, in certain instances, may be readily overlooked.” However, pictorial representation, while serving as a reminder to the lister, does not give a shopper enough information in order to meet the lister's exact specifications.

Also, Fraynd's patent does not provide a convenient integrated means to transport the list to market. Rather, Fraynd indicates that at the time of replenishment, the various indicator elements can merely be removed from the display surface and accumulated in a pouch, bag or like storage device and taken to the store. This does not provide a display method of the items to be purchased while performing the actual shopping function.

U.S. Pat. No. 6,250,006 issued to Berrier relates to a preprinted dry erase type board as a shopping aid.

U.S. Pat. No. 5,704,147 issued to Rellinger relates to a magnetic letter board assembly.

U.S. Pat. No. 5,144,750 issued to Mandel relates to a grocery-listing device comprised of a sliding punch.

Accordingly, there is a need of a listing system capable of: indicating exact specifications of brand, type, quality, and quantity of items so as to make the list unambiguous; including errands and other activities to be performed in conjunction with a shopping trip; and being fashioned so it is readily transportable. As will be disclosed below, the present invention provides a solution for these above-mentioned deficiencies.

### OBJECTS OF THE INVENTION

Accordingly, several objects and advantages of my invention are:(a) to provide a lightweight magnetic shopping list system that is easy to transport to and from the grocers.

(b) to provide a magnetic strip attached to the reverse side of the list so as to attach the list easily to the exterior of a refrigerator door.

(c) to provide a plurality of small, sheet magnets with either: words of common grocery and household items; words indicating size, quantity, and other qualifiers; words of errands to be performed in conjunction with the shopping trip; or advertiser's logos.

(d) to provide that the list and word magnets, when assembled for packaging, fit into clear plastic box of predetermined size which may be used subsequently as the carrying case to transport the list to the grocery store.

(e) to provide such list and word magnets which are easy to manufacture and simple and efficient to use and arrange.

### SUMMARY OF INVENTION

This invention relates to a magnetic shopping list system designed for the compilation of a grocery list that can conveniently be carried to the grocery store. However, while a description of the features of the present invention will be primarily used for compiling a grocery list, it should be emphasized herein that the system of the present invention can be readily adaptable to include a reminder system of any common tasks to be completed, especially in conjunction with a grocery store trip, such as “bank deposit,” or “dry cleaning,” etc.

The invention is lightweight, durable and inexpensive to produce. It is comprised of two types of parts: a lightweight, magnetic-receptive sheet, and a multitude of magnets with words and/or advertising logos.

### BRIEF DESCRIPTION OF DRAWINGS

FIG. 1 is a front plan view of the sheet with eleven word magnets magnetically attached.

FIG. 2 is a side perspective view of the reverse side of the sheet.

FIG. 3 is a front plan view of a word magnet.

FIG. 4 is a side view of a word magnet.

### DETAILED DESCRIPTION

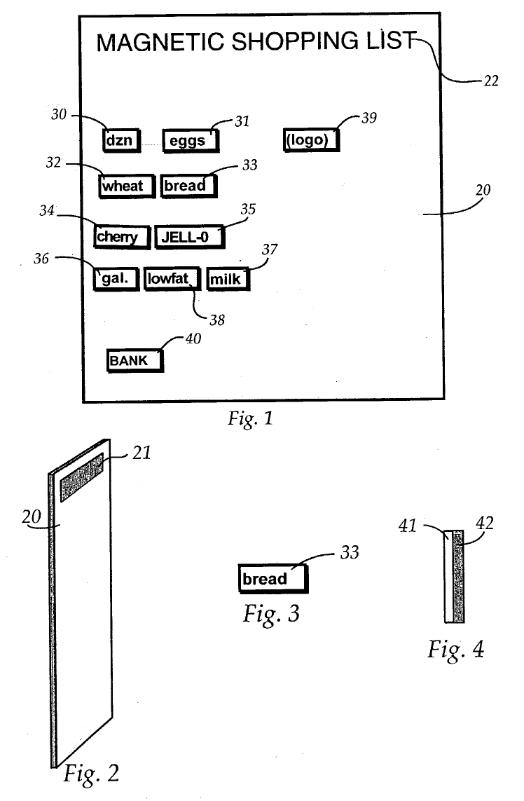

This invention relates to a magnetic shopping list system. The system is comprised of, as shown in FIGS. 1 and 2, a planar sheet 20 of lightweight, magnetically attractive material, with a label 22 indicating “Magnetic Shopping List.” The sheet 20 is otherwise unmarked, leaving the remaining space for placement of word magnets 30 through 40. Magnetic strip 21 is on the reverse of the magnetic sheet 20.

Word magnets 31, 33 and 37 are respective food items eggs, bread, and milk. Word magnets 30, 32, 34, 36 and 38 are respective qualifiers dzn., wheat, cherry, gal. and low fat. Word magnet 35 indicates “JELL-O,” a manufacturer's name brand item. Magnet 39 represents a manufacturer's logo of a grocery item. Magnet 40, “Bank,” represents a reminder of a task to be performed in conjunction with the shopping trip.

FIG. 3 and FIG. 4 are plan and side views of a single word magnet. The word magnet is comprised of a flexible magnetic sheeting material with a vinyl, paper or other thin coating that can be printed on.

Operation: The manner of using this system is in three distinct phases; before shopping, during shopping, and after shopping. There are two roles related to this system; the lister—the one compiling the list, and the shopper—the one purchasing the items on the list. The shopper and the lister may in fact be the same person, but because they are not necessarily the same person, the roles are distinguished here.

Before shopping, the list 20 is magnetically attached to a metal refrigerator door by a magnetic strip 21. Word magnets 30-40 are also attached to the refrigerator door. At this time, the list would be empty, and no word magnets 30-40 would be attached to the list.

When anyone in the household notices an item in short supply, they move the magnet from the refrigerator door to sheet 20. In this manner the household member acts as lister. As the time of the shopping trip nears, whoever in the household is responsible for grocery shopping scans the field of word magnet 30-40 for any other items that may need to be purchased and places them on sheet 20.

When the shopper is about to depart, they simply remove the sheet 20 with the word magnets of items to purchase attached, and place it in a clear plastic box (such as the one used for packaging the system at time of sale) or a plastic bag (not shown for purposes of clarity) so that the list and words can be seen easily while shopping. The sheet 20 is manufactured at a predetermined size such that it fits inside a variety of standard clear packaging material commonly found in many households, thus eliminating the need for a custom carrying case.

During shopping at the store, the shopper reviews the sheet 20 as they navigate the store aisles, locating the items to purchase that match their list and place them in their basket or shopping cart.

After the shopping trip, the shopper returns the sheet to the refrigerator door and transfers the items purchased from the sheet to the refrigerator door.

### CONCLUSION, RAMIFICATIONS, AND SCOPE

Accordingly, the reader will see that the Magnetic Shopping List system described in this invention is, easy to use, easy to transport, and kept conveniently located on the refrigerator door.

Although items 30 through 40 show a representative sample of word magnets, these should not be construed as the full inventory, but merely a sample for this invention's description. For example, the system could be supplied with a full range of general grocery items, or supplied with any specialty food inventory such as Italian, Greek, or Mexican.

Thus the scope of the invention should be determined by the appended claims and their legal equivalents, rather than by the examples given.

What is claimed is:

1. A grocery listing system comprising:
a. a sheet of lightweight, rigid, magnetic receptive material about 12 cm high, 12 cm wide and about 1.5 mm thick and,
b. a magnetic strip about 10 cm wide, 1.5 cm high and about 1.5 mm thick mounted to the reverse side of said sheet at a spaced location and,
c. a plurality of magnets about 1.2 cm high, 2.5 cm wide, 1.5 mm thick, with grocery item nouns printed thereon and,
d. a plurality of magnets about 1.2 cm high, 2.5 cm wide, 1.5 mm thick with adjectives printed thereon and,
e. a plurality of magnets about 1.2 cm high, 2.5 cm wide, 1.5 mm thick with numbers printed thereon and,
e. a plurality of magnets about 1.2 cm high, 2.5 cm wide, 1.5 mm thick with common household activity verbs of printed thereon and,
f. a plurality of magnets about 1.2 cm high, 2.5 cm wide, 1.5 mm thick with manufacturer's logos printed thereon and,
g. a plurality of magnets about 1.2 cm high, 2.5 cm wide, 1.5 mm thick with a blank space allowing a user to write a description of a desired household item thereon.

2. A method for using a grocery listing system, comprising:
a. providing a list system of the type comprising a sheet of magnetic receptive material having a magnetic strip mounted on the reverse side thereof,
b. means for magnetically attaching said sheet to a refrigerator door,
c. providing a multitude of magnets with words printed thereon,
d. means for magnetically attaching said magnets to said refrigerator door,
e. means for magnetically attaching said magnets to said sheet,
f. arranging said magnets on said sheet so that said magnets form word groups indicating specific qualities and quantities of items to be purchased and/or word groups indicating common household activities to be performed,
g. disposition of any of said word magnets on said sheet being indicative of a reminder to purchase a product or perform some task in conjunction with a shopping trip,
h. transfer of any of said word magnets to the said sheet being indicative of a request to purchase or perform some task in conjunction with a shopping trip,
i. means for removal and transport of said sheet with said word magnets magnetically attached from said refrigerator door,
j. means for reviewing said sheet and said magnets while on a shopping trip,
k. means to remove said magnets from said sheet upon return from a shopping trip,
whereby someone can easily keep, compile, carry, refer to, and reuse said grocery listing system.
